(19) United States
(12) Patent Application Publication
(10) Pub. No.: US 2026/0335989 A1
(43) Pub. Date: Oct. 29, 2026

(54) CEMENTED CARBIDE DRILL

(71) Applicant: NACHI-FUJIKOSHI CORP., Tokyo (JP)

(72) Inventors: Shohei HORIKAWA, Toyoma (JP); Junichi NOSHIRO, Toyama (JP)

(21) Appl. No.: 19/704,677

(22) Filed: Jun. 11, 2026

Related U.S. Application Data
(63) Continuation of application No. PCT/JP2024/044073, filed on Dec. 12, 2024.

(30) Foreign Application Priority Data
Dec. 28, 2023 (JP) 2023-222074

(51) Int. Cl. B23B 51/02

(52) U.S. Cl. CPC B23B 51/02; B23B 2251/04; B23B 2251/40

(57) ABSTRACT

A cemented carbide drill includes cutting edges each provided outward from a rotational axis of the cemented carbide drill, rake faces each formed continuously with each cutting edge and on a front side of each cutting edge in a rotation direction of each cutting edge, flank faces each formed continuously with each cutting edge and on a rear side of each cutting edge in the rotation direction of each cutting edge, first margins each formed continuously outward from each flank face, main flutes each formed adjacent to each cutting edge, and sub flutes each formed parallel to each main flute and on a rear side of each first margin in a rotation direction of each first margin.

### CROSS-REFERENCE TO RELATED APPLICATIONS

This application is a continuation of International Application No. PCT/JP2024/044073, filed on Dec. 12, 2024, which claims the benefit of priority of the prior Japanese Patent Application No. JP 2023-222074, filed on Dec. 28, 2023, the entire contents of which are incorporated herein by reference.

### BACKGROUND

### 1. Technical Field

The present disclosure relates to a cemented carbide drill provided with sub flutes on an outer peripheral portion thereof, the sub flutes being for allowing a cutting fluid (coolant) to flow therethrough.

### 2. Related Art

To cool a drill and a workpiece material when drilling is performed using the drill, the drilling has conventionally been performed using a so-called external lubrication method, in which a coolant is applied to the drill and workpiece material from a machine tool. Furthermore, as disclosed in Japanese Examined Utility Model Publication No. 61-028654, flutes allowing a coolant to pass therethrough may be provided on an outer peripheral portion of a drill, and the coolant externally supplied from a machine tool may thereby be efficiently delivered to a tip of the drill.

Furthermore, instead of the external lubrication method, a drill and a workpiece material may be cooled during drilling by using an oil-hole drill, which forces a coolant delivered from a machine tool from a rear end to a tip of the drill and injects the coolant from near the cutting edges, as disclosed in Japanese Unexamined Patent Application Publication No. 2020-104253.

### SUMMARY

However, with the drill disclosed in Japanese Examined Utility Model Publication No. 61-028654, it is difficult to achieve a sufficient cooling effect for a workpiece material having low thermal conductivity, typified by stainless steel, and welding to a rake face of the drill is promoted, causing chipping, thereby necessitating reduction (moderation) of machining conditions.

Furthermore, the drill disclosed in Japanese Unexamined Patent Application Publication No. 2020-104253 is limited to use with a machine tool having a mechanism capable of forcing a coolant into the drill, that is, a machine tool including a so-called internal lubrication mechanism, and, in addition, a drill having such an internal lubrication mechanism (oil-hole drill) has been a cause of cost increase as compared with a general-purpose drill.

Accordingly, it is preferable to provide a cemented carbide drill enabling a workpiece material having low thermal conductivity to be machined using a general-purpose machine tool, even under normal drilling conditions.

In some embodiments, a cemented carbide drill includes: cutting edges each provided outward from a rotational axis of the cemented carbide drill; rake faces each formed continuously with each cutting edge and on a front side of each cutting edge in a rotation direction of each cutting edge; flank faces each formed continuously with each cutting edge and on a rear side of each cutting edge in the rotation direction of each cutting edge; first margins each formed continuously outward from each flank face; main flutes each formed adjacent to each cutting edge; and sub flutes each formed parallel to each main flute and on a rear side of each first margin in a rotation direction of each first margin, each cutting edge having a tip including a first chamfered surface on a flank face side of the tip and a second chamfered surface on a rake face side of the tip.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a front view of a cemented carbide drill 10;

FIG. 2 is a plan view of the cemented carbide drill 10;

FIG. 3 is a left side view of the cemented carbide drill 10 illustrated in FIG. 1;

FIG. 4 is a view of the cemented carbide drill 10 illustrated in FIG. 2, as viewed from an arrow A; and

FIG. 5 is a diagram additionally illustrating, in FIG. 4, a first chamfer amount e1 and a second chamfer amount e2.

### DETAILED DESCRIPTION

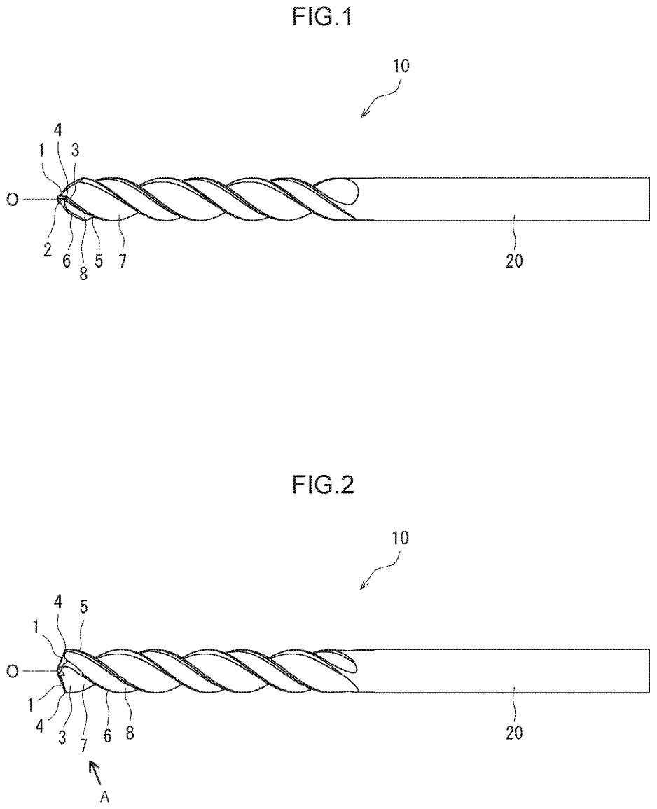

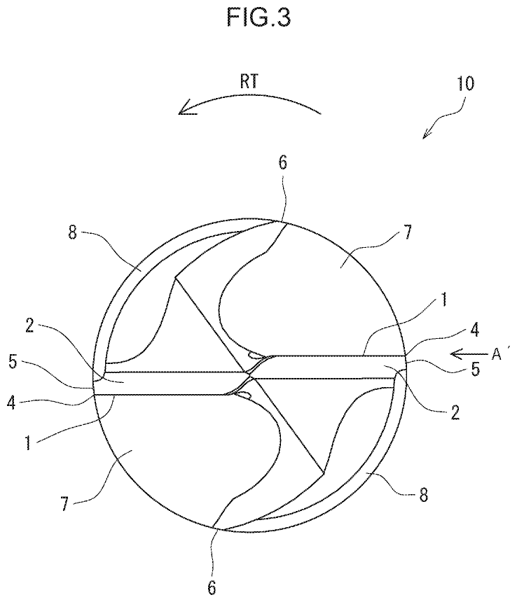

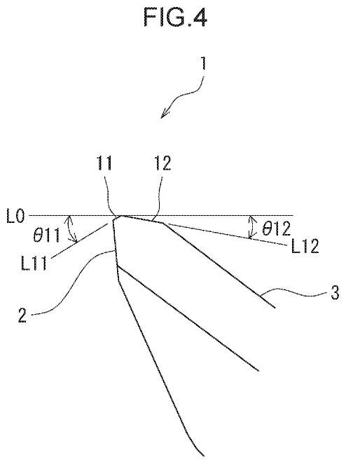

An embodiment of a cemented carbide drill will be described using the drawings. A front view of a cemented carbide drill 10, which is an embodiment, is illustrated in FIG. 1, a plan view thereof in FIG. 2, and a left side view thereof in FIG. 3. Furthermore, a schematic enlarged view near an outer peripheral corner 4 of the cemented carbide drill 10 illustrated in FIG. 1 is illustrated in FIG. 4. The cemented carbide drill 10 includes two cutting edges 1 and 1 at a tip portion thereof as illustrated in FIG. 1 to FIG. 3 and further includes, on front sides of the respective cutting edges 1 and 1 in a rotation direction RT of the respective cutting edges 1 and 1: rake faces 3 and 3; and two main flutes 7 and 7 formed along a longitudinal direction (axial direction) of the cemented carbide drill 10.

Furthermore, the cemented carbide drill 10 includes flank faces 2 and 2 on rear sides of the respective cutting edges 1 and 1 in the rotation direction RT of the respective cutting edges 1 and 1; first margins (front margins) 5 and 5 via outer peripheral corners 4 and 4 on an outer peripheral side of the cutting edges 1 and 1 and along a circumferential direction of the cemented carbide drill 10; and second margins (rear margins) 6 and 6 on the rear sides of the first margins 5 and 5 in the rotation direction RT. Furthermore, the cemented carbide drill 10 includes two sub flutes 8 and 8, each sub flute 8 being between the first margin (front margin) 5 and the second margin (rear margin) 6, the two sub flutes 8 and 8 being helically formed toward a shank 20 from a tip side of the cemented carbide drill 10 so as to be parallel to the two main flutes 7 and 7 along the axial direction (longitudinal direction) of the cemented carbide drill 10.

That is, the two sub flutes 8 and 8 are formed on rear sides of the main flutes 7 and 7 in the rotation direction RT of the cemented carbide drill 10 as illustrated in FIG. 1 to FIG. 3, the first margins (front margins) 5 and 5 are respectively provided on rotation direction RT sides of the sub flutes 8 and 8, and the second margins (rear margins) 6 and 6 are respectively provided on sides opposite to the rotation direction RT sides of the sub flutes 8 and 8.

A form of a tip of a cutting edge in the cemented carbide drill will be described next using the drawings. A view of the cemented carbide drill 10 illustrated in FIG. 2, as viewed from an arrow A, is illustrated in FIG. 4. At a tip of a cutting edge 1 of the cemented carbide drill 10 of the present embodiment, chamfering is provided on both a flank face 2 side and a rake face 3 side thereof. In the cemented carbide drill 10 of the embodiment, as illustrated in FIG. 4, a first chamfered surface 11 formed by the chamfering on the flank face 2 side at the tip of the cutting edge 1 and a second chamfered surface 12 formed by the chamfering on the rake face 3 side at the tip of the cutting edge 1 are included. FIG. 4 is a view of a vicinity of the outer peripheral corner 4 of the cemented carbide drill 10 as viewed from a direction of the arrow A illustrated in FIG. 2. The direction of the arrow A is a direction toward the center of a tool along a direction in which the cutting edge 1 extends from an outermost peripheral position of the cutting edge 1. An arrow A′ illustrated in FIG. 3 is an arrow that would be drawn in a case where the arrow A in FIG. 2 is projected in the viewing direction of FIG. 3 (the direction viewed from the left side of the cemented carbide drill 10 illustrated in FIG. 1), and is an arrow written to facilitate understanding that the position indicated by the arrow A corresponds to the direction in which the cutting edge 1 extends.

Furthermore, for convenience of description, the cemented carbide drill 10 of the embodiment illustrated in FIG. 1 to FIG. 5 is described on the assumption that the cutting edge 1 extends linearly in the direction of the arrow A, but the present invention is not limited to the embodiment. In practice, machining errors may occur, for example, and such drills including the machining errors are not intended to be excluded from the subject matter of the present invention.

The first chamfered surface 11 provided on the flank face 2 side and the second chamfered surface 12 provided on the rake face 3 side each form a predetermined angle with respect to a virtual straight line L0 that is parallel to a rotational axis O, as illustrated in FIG. 4. In particular, the first chamfered surface 11 preferably has an angle θ11 formed between the virtual straight line L0 and a virtual extension line L11 of the first chamfered surface 11 in a range of 15° or more and 50° or less, and the second chamfered surface 12 preferably has an angle θ12 formed between the virtual straight line L0 and a virtual extension line L12 of the second chamfered surface 12 in a range of more than 0° and not more than 15°. The angle θ11 mentioned above refers to the angle θ11 formed between the virtual straight line L0 and the virtual extension line L11 of the first chamfered surface 11 in a case where the vicinity of the outer peripheral corner 4 of the cemented carbide drill 10 is viewed from the direction of the arrow A written in FIG. 2. Similarly, the angle θ12 mentioned above refers to the angle θ12 formed between the virtual straight line L0 and the virtual extension line L12 of the second chamfered surface 12 in a case where the vicinity of the outer peripheral corner 4 of the cemented carbide drill 10 is viewed from the direction of the arrow A written in FIG. 2.

### EXAMPLES

In order to confirm the influence of chamfering applied to cutting edges of cemented carbide drills on the state of the cutting edges, cutting tests (hereinafter, referred to as the present tests) were conducted, and the following description is on results of these tests. In the present tests, three types of cemented carbide drills, the cemented carbide drill of the embodiment illustrated in FIG. 1 to FIG. 3 (hereinafter, referred to as the invention product), and cemented carbide drills not according to the present invention (hereinafter, referred to as the first conventional product and the second conventional product), were used.

The chamfering of the invention product was set such that the angle θ11 of the first chamfered surface illustrated in FIG. 4 was 25° and the angle θ12 of the second chamfered surface was 8°. In contrast, the chamfering of the first conventional product was set such that the angle θ11 of the first chamfered surface illustrated in FIG. 4 was 25° and the second chamfered surface was not provided, and the chamfering of the second conventional product was set such that the first chamfered surface illustrated in FIG. 4 was not provided and the angle θ12 of the second chamfered surface was 8°. Diameters of these three types of cemented carbide drills were each 6 mm.

The cutting was performed under the following conditions in the present tests; and when the total number of drilled holes reached 100, the cutting was interrupted, and states of tip portions of the cutting edges of the three types of cemented carbide drills, the invention product and first and second conventional products, were examined.
Cutting speed: 40 m/min
Feed rate: 0.15 mm/rev
Drilling depth: 30 mm
Workpiece material: austenitic stainless steel (SUS304)

As a result of the present tests, traces of chipping due to welding of the workpiece material on the rake face side were observed at the tip portion of the cutting edges of the first conventional product when the number of drilled holes reached 100. Furthermore, the state of welding of the workpiece material on the rake face side at the tip portion of the cutting edges of the second conventional product when the number of drilled holes reached 100 was improved as compared with the first conventional product, but traces of chipping were still observed.

In contrast, no welding of the workpiece material was observed on either the rake face side or the flank face side at the tip portion of the cutting edges of the invention product when the number of drilled holes reached 100, and no traces of chipping were observed either. From the above test results, it has been found that, by performing chamfering with a predetermined angle on both the flank face side and the rake face side at the tip portion of the cutting edges of a cemented carbide drill, welding of chips to the flank face and the rake face is able to be reduced for workpiece materials, particularly materials that are difficult to be cut, typified by stainless steel.

In the above described example, it was confirmed from the viewpoint of chip welding that including the first chamfered surface 11 and the second chamfered surface 12 constitutes a minimum technical requirement, but in order to further narrow down embodiments and derive more preferable embodiments from other evaluation viewpoints relating to drills, test results of an additional example will be described below.

The purpose of the additional example is to, in a case where the condition of including the first chamfered surface 11 and the second chamfered surface 12 tested in the above described example is taken as a highest-priority condition, further add other conditions so as to investigate in detail the influence of different conditions set for chamfer shapes on forms of chips and chipping of the cutting edges, and thereby derive more preferable chamfer conditions.

Herein, tests were individually conducted for evaluation of the shape of the second chamfered surface 12 formed by chamfering on the rake face 3 side illustrated in FIG. 4 and the shape of the first chamfered surface 11 formed by chamfering on the flank face 2 side.

Evaluation of Chamfer Shape on Rake Face Side

In this example, the chamfer shape on the rake face side was evaluated first, and the influence of the chamfer angle on chip breakability was investigated. An attempt was thereby made to determine an optimal chamfer shape from which improvement in cutting stability is able to be expected.

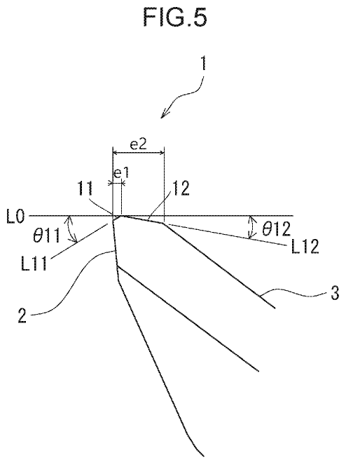

Specifically, the following conditions were set for the chamfer shape on the rake face side and cutting tests were conducted. Firstly, a first chamfer amount e1 illustrated in FIG. 5 was set to 0.050 mm, a second chamfer amount e2 to 0.15 mm, and the chamfer angle (angle of the second chamfered surface) θ12 to three levels of 0°, 8°, and 16°. These tests were conducted under the following conditions: drill diameter: 6 mm, cutting speed: 40 m/min, feed rate: 0.15 mm/rev, drilling depth: 18 mm, workpiece material: austenitic stainless steel (SUS304). The chamfer amounts e1 and e2 are lengths of the chamfered surfaces 11 and 12 in a direction parallel to the virtual straight line L0, respectively. With respect to the embodiment, the chamfered surfaces 11 and 12 are described as having constant chamfer amounts e1 and e2 over the entire width of the cutting edge 1, but in practice, since some machining errors occur, when the chamfer amounts e1 and e2 are not constant over the entire width of the cutting edge 1, the maximum lengths of lengths of the chamfered surfaces 11 and 12 in the direction parallel to the virtual straight line L0 are defined as the chamfer amounts e1 and e2.

An item evaluated in these tests is the presence or absence of chip breakability. Specifically, when chips become elongated, chip clogging and entanglement of chips around the tool (drill) may occur, welding of the workpiece material to the rake face may cause chipping or breakage of the cutting edges, and this was thus observed and the purpose was to identify optimal conditions for performing stable cutting.

As a result of the tests, the setting of the chamfer angle of 8° showed the most favorable results. Under the condition, chip breakability was excellent, no chipping occurred even after drilling 225 holes, and it was confirmed that stable cutting was possible.

In contrast, in the setting with the chamfer angle of 0°, after drilling 125 holes, the chips were generally broken and discharged, but as compared with the chamfer angle of 8°, a tendency for the chips to become elongated was observed. Furthermore, in the setting with the chamfer angle of 16°, some chips became elongated, and after drilling 125 holes, a tendency for the chips to become entangled around the main flutes of the drill without breaking began to be observed. That is, not only from the viewpoint of chip welding, which is the highest-priority matter, but also from the viewpoint of chip breakability as a more preferable condition, it can be said that a more optimal numerical range of the angle θ12 of the second chamfered surface lies within a range greater than 0° and less than 16°. That is, it can be said that a preferable range of the angle θ12 of the second chamfered surface lies within a range of more than 0° and not more than 15°. By inference, since the chamfer angle of 8° provided favorable results, it can be said that a more preferable range of the angle θ12 of the second chamfered surface is distributed within a range of 4° or more and 12° or less. Furthermore, from the test results, it was also confirmed that the magnitude of the chamfer amount on the rake face side (second chamfer amount e2) has validity in a range of 0.10 mm or more and 0.20 mm or less, which is a range in the vicinity of 0.15 mm.

### Evaluation of Chamfer Shape on Flank Face Side

Next, on the basis of the conditions determined to be optimal for the chamfer shape on the rake face side described above (the chamfer amount of 0.15 mm and the chamfer angle of 8°), evaluation of the chamfer shape on the flank face side was conducted. Similar cutting tests were conducted for the chamfer shape on the flank face side and chip breakability and the presence or absence of chipping of the cutting edges were investigated.

Specifically, with respect to the chamfer shape on the flank face 2 side illustrated in FIG. 5, the chamfer amount (first chamfer amount e1) was set to three levels of 0.030 mm, 0.050 mm, and 0.070 mm, the chamfer angle (angle of the first chamfered surface: θ11) was set to three levels of 15°, 25°, and 40°, and the cutting tests were conducted. The tests were conducted under cutting conditions similar to the tests for the chamfer shape on the rake face side. The chamfer amounts e1 and e2 are lengths of the chamfered surfaces 11 and 12 in the direction parallel to the virtual straight line L0, respectively. With respect to the embodiment, the chamfered surfaces 11 and 12 are described as having constant chamfer amounts e1 and e2 over the entire width of the cutting edge 1, but in practice, since some machining errors occur, when the chamfer amounts e1 and e2 are not constant over the entire width of the cutting edge 1, the maximum lengths of lengths of the chamfered surfaces 11 and 12 in the direction parallel to the virtual straight line L0 are defined as the chamfer amounts e1 and e2.

As a result of the tests, no difference in chipping breakability was observed with respect to the chamfer amount and chamfer angle on the flank face side. That is, from the viewpoint of chip breakability, it was found that the angle θ11 of the first chamfered surface has no problem at least at 15° or more and 40° or less. This range is merely a more preferable range, and it is further inferred that the angle θ11 of the first chamfered surface would present no problem from the viewpoint of chip breakability in a range slightly smaller than this range and in a range slightly larger than this range, up to 50°.

Subsequently, as a further technical evaluation item different from chip welding and chip breakability, a preferable appropriate range for chipping of the cutting edges with respect to long-term use was confirmed.

With respect to chipping of the cutting edges, the condition with the chamfer angle of 25° and the chamfer amount of 0.050 mm showed the most favorable results. Under the condition, no chipping of the cutting edges occurred after drilling 225 holes, and stable machining was confirmed.

In contrast, under conditions in which the chamfer angle was 25° and the chamfer amounts were 0.030 mm and 0.070 mm, slight chipping of the cutting edges occurred after drilling 225 holes, but since welding was sufficiently reduced as compared with a conventional shape (a shape having no first chamfered surface or no second chamfered surface), there were improvements as compared with the conventional shape from the viewpoint of machining life.

Furthermore, even under conditions with the chamfer angles of 15° and 40°, a tendency for slight chipping to occur at the corner portions of the cutting edges was observed, but since welding was sufficiently reduced as compared with a conventional shape (a shape having no first chamfered surface or no second chamfered surface), machining life is improved as compared with the conventional shape.

From the above results, with respect to the chamfer shape on the flank face side, it was found that, when the angle θ11 of the first chamfered surface is in the range of 15° or more and 50° or less, welding is improved, and it was further found that chip breakability is also excellent.

Furthermore, from the aspect of evaluation of chipping of the cutting edges with respect to long-term use, it was found that the first chamfered surface at 25° and the chamfer amount of 0.050 mm are optimal, and it can thus be said that it is more preferable for the angle θ11 of the first chamfered surface to be within a range of 20° or more and 30° or less. Furthermore, it can be said that it is more preferable that the magnitude of the first chamfer amount e1 is within a range of 0.040 mm or more and 0.060 mm or less, which is a range in the vicinity of 0.050 mm. Within this more preferable range of conditions, chipping of the cutting edges and corner portions is reduced, thereby ensuring stability during machining, and a further improvement effect is also able to be expected in that cutting performance is maintained even as the number of drilled holes increases.

In summary of the test results of this example, it was found that a preferable range of the angle θ12 of the second chamfered surface for improving machining stability would lie within the range of more than 0° and not more than 15°. Furthermore, it was also confirmed that the magnitude of the second chamfer amount e2 has validity in the range of 0.10 mm or more and 0.20 mm or less.

Furthermore, it was confirmed that the angle θ11 of the first chamfered surface on the flank face side has validity for improvement effects from the aspect of welding reduction and the aspect of chip breakability in the range of 15° or more and 50° or less, and it was further found that, from the aspect of durability, the range of 20° or more and 30° or less is more preferable. In addition, with respect to the first chamfer amount e1, it was confirmed that a range of more than 0.030 mm and not more than 0.070 mm has validity for improvement effects from the aspect of welding reduction and the aspect of chip breakability, and it was further found that the range of 0.040 mm or more and 0.060 mm or less is more preferable also from the aspect of durability.

A cemented carbide drill of the disclosure has a plurality of helical flutes of different forms including main flutes and sub flutes and thus provides an effect of allowing a coolant to reach cutting edges at a tip of the cemented carbide drill still under drilling conditions of an external lubrication method using a machine tool not including an internal lubrication mechanism. In addition, in a case where a workpiece material is a material, typified by stainless steel, which is difficult to be cut and has low thermal conductivity and for which machining temperature of cutting edges tends to increase, providing minute chamfering on both flank face sides and rake face sides of the cutting edges enables welding of chips to the cutting edges (the flank faces and the rake faces) to be reduced and chip breakability to be improved at the same time.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A cemented carbide drill comprising:
cutting edges each provided outward from a rotational axis of the cemented carbide drill;
rake faces each formed continuously with each cutting edge and on a front side of each cutting edge in a rotation direction of each cutting edge;
flank faces each formed continuously with each cutting edge and on a rear side of each cutting edge in the rotation direction of each cutting edge;
first margins each formed continuously outward from each flank face;
main flutes each formed adjacent to each cutting edge; and
sub flutes each formed parallel to each main flute and on a rear side of each first margin in a rotation direction of each first margin, each cutting edge having a tip including a first chamfered surface on a flank face side of the tip and a second chamfered surface on a rake face side of the tip.

2. The cemented carbide drill according to claim 1, wherein an angle θ11 formed between the first chamfered surface and the rotational axis of the cemented carbide drill is in a range of 15° or more and 50° or less, and an angle θ12 formed between the second chamfered surface and the rotational axis of the cemented carbide drill is in a range of more than 0° and not more than 15°.
